(19) United States
(12) Patent Application Publication
(10) Pub. No.: US 2022/0318763 A1
(43) Pub. Date: Oct. 6, 2022

(54) METHODS AND SYSTEMS FOR GENERATING AND OUTPUTTING TASK PROMPTS

(71) Applicant: TOYOTA RESEARCH INSTITUTE, INC., Los Altos, CA (US)

(72) Inventors: Matthew Lee, Mountain View, CA (US); Yanxia Zhang, Foster City, CA (US); Rumen Iliev, Millbrae, CA (US); Charlene C. Wu, San Francisco, CA (US); Kent Lyons, Los Altos, CA (US); Yue Weng, San Mateo, CA (US)

(73) Assignee: TOYOTA RESEARCH INSTITUTE, INC., Los Altos, CA (US)

(21) Appl. No.: 17/220,563

(22) Filed: Apr. 1, 2021

(51) Int. Cl. G06Q 10/10; G06N 20/00

(52) U.S. Cl. CPC G06Q 10/1097; G06N 20/00

(57) ABSTRACT

A method for generating and outputting a prompt for performing a task in a designated time segment is provided. The method includes obtaining, from a plurality of sensors, context data associated of the user related to time segments, categorizing each of the time segments into one of a plurality of thought states based on the context data, mapping a task from a task dataset associated with the user into one of the plurality of thought states, and generating a prompt for performing the task during a designated time segment of the time segments, the designated time segment corresponding to the one of the plurality of thought states to which the task is mapped.

### TECHNICAL FIELD

The present disclosure relates to a task prompt generation system, and in particular, to a task prompt generation system that generates a prompt for performing a task during a time segment that corresponds to a particular thought state associated with the task.

### BACKGROUND

Conventional systems enable users to interact with and include a plurality of tasks of varying difficulty into digital calendars. Moreover, these tasks may be scheduled by the user using voice recognition based techniques, manual entry, and so forth. However, conventional systems lack the ability to facilitate the efficient performance of tasks of varying levels of difficult based on the thought states associated with these users.

Accordingly, a need exists for enabling users to efficiently and effectively complete routine and complex tasks by factoring in the context, physiological conditions, and thought states of these users during these time periods.

### SUMMARY

In one embodiment, a method generating and outputting a prompt for performing a task in a designated time segment is provided. The method includes obtaining, from a plurality of sensors, context data associated of the user related to time segments, categorizing each of the time segments into one of a plurality of thought states based on the context data, mapping a task from a task dataset associated with the user into one of the plurality of thought states, and generating a prompt for performing the task during a designated time segment of the time segments, the designated time segment corresponding to the one of the plurality of thought states to which the task is mapped.

In another embodiment, a system that is configured to generate and output a prompt for performing a task in a designated time segment is provided. The system includes a plurality of sensors and a device that includes a processor. The processor is configured to obtain, from a plurality of sensors, context data associated of the user related to time segments, categorize each of the time segments into one of a plurality of thought states based on the context data, map a task from a task dataset associated with the user into one of the plurality of thought states, and generate a prompt for performing the task during a designated time segment of the time segments, the designated time segment corresponding to the one of the plurality of thought states to which the task is mapped.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts an example operating environment of the task prompt generation system of the present disclosure; according to one or more embodiments described and illustrated herein;

FIG. 2 schematically depicts non-limiting components of the devices of the present disclosure, according to one or more embodiments described and illustrated herein;

FIG. 3 depicts a flow chart for generating and outputting a prompt for performing a task in a designated time segment, according to one or more embodiments described and illustrated herein;

FIG. 4 illustrates a flowchart for training the artificial intelligence trained model that is utilized by the task prompt generation system of the present disclosure to generate prompts, according to one or more embodiments described and illustrated herein;

FIG. 5 schematically depicts an example operation of the task prompt generation system of the present disclosure in which prompts for performing a routine task and a complicated task are output onto a display of a mobile device, according to one or more embodiments described and illustrated herein; and

FIG. 6 schematically depicts another example operation of the task prompt generation system in which a prompt for performing a complicated task is automatically output onto a display of the mobile device; according to one or more embodiments described and illustrated herein.

### DETAILED DESCRIPTION

The embodiments of the present disclosure describe a method and system for generating and outputting task prompts onto displays of various devices or audible prompts. These task prompts are generated and displayed to various users during certain time segments in order to maximize the likelihood of completion of these tasks in an efficient and consistent manner. To this end, in embodiments, the task prompt generation system of the present disclosure may utilize an artificial intelligence neural network trained model that is trained using context data and physiological data associated users during these time segments, e.g., one hour or two hour time blocks during a typical work day spanning across weeks, months, and so forth.

Based on this training, the task prompt generation system may identify different time segments that are suitable for performing complex tasks, routine tasks, and so forth. Specifically, the task prompt generation system may categorize tasks into a long-term thought state and a short-term reactive thought state, categorize time segments in association with the long-term thought state and the short term reactive thought state, and generate a prompt for performing the task during a designated time segment that corresponds to the thought state to which the task is mapped.

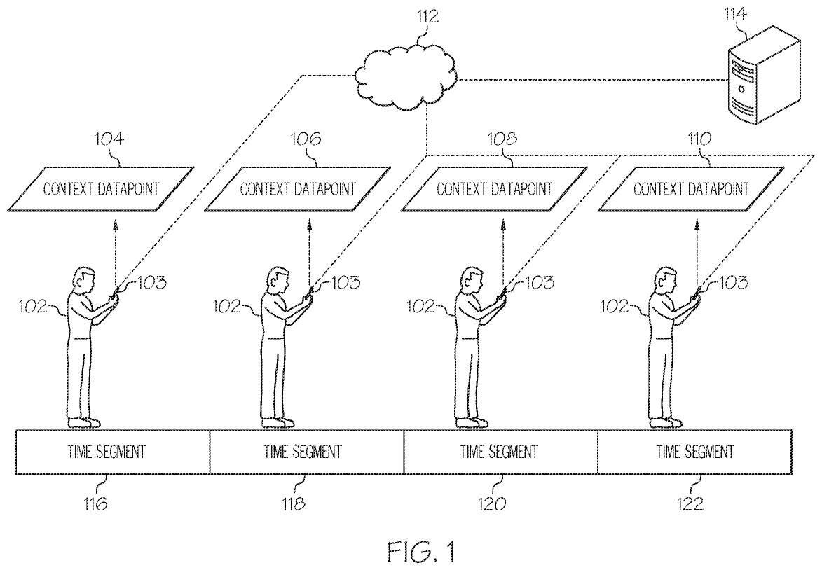

Referring now to the drawings, FIG. 1 schematically depicts an example operating environment of the task prompt generation system of the present disclosure, according to one or more embodiments described and illustrated herein. As illustrated, FIG. 1 depicts a user 102 operating a mobile device 103 during time segments 116, 118, 120, and 122. These time segments may correspond with various time blocks during the day, week, month, and so forth. For example, these time segments may correspond with one hour or two hour time blocks during a day, every, other day, once or twice a week, and so forth. Other such time blocks are also contemplated. While the time segments in FIG. 1 are illustrated as being continuous, the time segments may be distributed discontinuously. For example, the time segment 116 may be a time segment between 10:00 am and 10:30 am, Monday, and time segment 118 may be a time segment between 1:00 pm and 1:30 pm, Monday.

[NV] A processor (e.g., a processor 202) of the mobile device 103 may, while operating in conjunction with one or more sensors installed as part of the mobile device 103 or embedded within an additional device worn by the user 102 (e.g. a FitBit®, an iWatch®, etc.), gather various types of context data (e.g., indicated by context datapoints 104, 106, 108, and 110) based on the interactions between the user 102 and the mobile device 103. Specifically, the context datapoints 104, 106, 108, and 110 may relate to context data associated with the user 102 that is obtained during time segments 116, 118, 120, and 122. Specifically, during certain time periods during the day, week, month, and so forth, the mobile device 103 may gather physiological data, data related to the number of emails that the user may send at certain times during the day, a reaction time of the user associated with scheduling tasks, the types of events the user may schedule and attend during these time periods, the frequency with which the user may reschedule, cancel, or modify scheduled events during these time periods, and so forth.

Context data may also be gathered from an electronic calendar associated with the user 102. The physiological data may include data such as a pulse rate, a heart rate, a body temperature, the number of steps that the user 102 has taken, a distance the user 102 may have walked, and so forth. Physiological data may be indicative of various conditions associated with the user, e.g., a relaxed condition of the user, an excited condition of the user, and so forth, during various time segments. This data may be collected, collated, and stored locally in memory (e.g., memory modules 206) of the mobile device 103 in addition to being stored within memory of the server 114. It is further noted that such data may be communicated from the mobile device 103 to the server 114 via the communication network 112 in real time. Additionally, the server 114 may communicate such data via the communication network 112 to the mobile device 103 in real time.

Additionally, one or more artificial intelligence based software applications may operate on and be accessed via the mobile device 103. In embodiments, physiological data related to the user 102 and data relating to the user's interactions with the mobile device 103, and one or more external devices that are accessed via the mobile device 103, are included as part of a dataset (e.g., a training dataset) that is updated in real time. The updated training dataset also includes real time feedback from the user 102 regarding tasks that are performed during various time segments.

All of this data and an artificial intelligence neural network based algorithm is utilized by the mobile device 103 to generate and train an artificial intelligence neural network model. In embodiments, the artificial intelligence neural network trained model may be utilized to generate and output a prompt onto a display (e.g., a display 216) of the mobile device 103 that recommends that a user perform a task. The prompt may be generated based on the difficulty of a task. In other words, if the task in the generated prompt is a complex one that requires creative thinking, significant organization and analysis of information, and so forth (e.g., writing an article, working on improving aspects of a product, coming up with ideas for a new product line, etc.), these tasks may be associated with a long-term based thought state. In other words, a thought state that requires the user 102 to expend significant mental energy and time thinking about solving a complex problem. To this end, these tasks may be displayed as a prompt on the mobile device 103 of the user 102 during time periods that are suitable for performing such tasks.

In embodiments, the artificial intelligence neural network trained model may generate and output a prompt associated with such complicated tasks during a particular time segment in which, as the data analysis may suggest, the user 102 has typically performed such tasks. Additionally, the analysis of the physiological data associated with the user 102 may indicate that a particular time segment may also be suitable for the effective and efficient completion of complex tasks. For example, the analysis of the physiological data, in conjunction with other context data, may indicate that the body temperature, heart rate, pulse rate, and other vital signs of the user 102 is at an equilibrium level between 6:00 AM to 8:00 AM, which may indicate that the user 102 may be able to concentrate on and solve complicated problems during this time.

Alternatively, the heart rate and pulse rate may be relatively heightened during another time segment, e.g., between 10:00 AM to 11:00 AM, which may indicate that the user 102 is energetic, excited, highly active, somewhat distracted, and so forth. As such, this time segment may be suitable for performing several routine tasks such as scheduling meetings, answering phone calls, and so forth, as such tasks do not require a significant amount of concentration. These tasks may be associated with a short-term reactive thought state. It is noted that a prompt may be generated and output onto a display (e.g., the display 216) of the mobile device 103 that includes a group of similar tasks that may be performed within a particular time segment. A plurality of other types of tasks may be generated and output onto the display of the mobile device 103.

It is noted also that while the interactions of the user 102 with the mobile device 103 is discussed, the prompt generation system described in the present disclosure may be implemented within one or more vehicle systems as well. Specifically, a processor (e.g., a processor 222) of a vehicle (not depicted) may also be configured to detect context data, physiological data, and so forth, associated with the user 102. Moreover, the vehicle, just as in the mobile device 103, may be configured to communicate with one or more devices that are external to the vehicle, and store the context data and the physiological data locally in memory (e.g., one or more memory modules 226) of the vehicle, or communicate this data to the server 114 through the communication network 112.

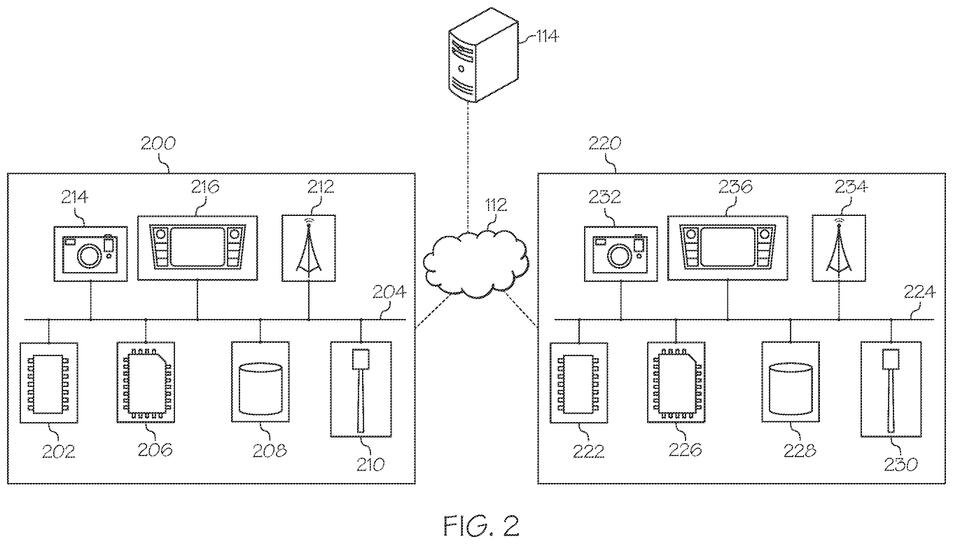

FIG. 2 schematically depicts non-limiting components of the devices of the present disclosure, according to one or more embodiments described and illustrated herein.

FIG. 2 schematically depicts non-limiting components of a mobile device system 200 and a vehicle system 220, according to one or more embodiments shown herein. Notably, while the mobile device system 200 is depicted in isolation in FIG. 2, the mobile device system 200 may be included within a vehicle. A vehicle into which the vehicle system 220 may be installed may be an automobile or any other passenger or non-passenger vehicle such as, for example, a terrestrial, aquatic, and/or airborne vehicle. In some embodiments, these vehicles may be autonomous vehicles that navigate their environments with limited human input or without human input.

The mobile device system 200 and the vehicle system 220 may include processors 202, 222. The processors 202, 222 may be any device capable of executing machine readable and executable instructions. Accordingly, the processors 202, 222 may be a controller, an integrated circuit, a microchip, a computer, or any other computing device.

The processors 202, 222 may be coupled to communication paths 204, 224, respectively, that provide signal interconnectivity between various modules of the mobile device system 200 and vehicle system 220. Accordingly, the communication paths 204, 224 may communicatively couple any number of processors (e.g., comparable to the processors 202, 222) with one another, and allow the modules coupled to the communication paths 204, 224 to operate in a distributed computing environment. Specifically, each of the modules may operate as a node that may send and/or receive data. As used herein, the term “communicatively coupled” means that the coupled components are capable of exchanging data signals with one another such as, for example, electrical signals via conductive medium, electromagnetic signals via air, optical signals via optical waveguides, and the like.

Accordingly, the communication paths 204, 224 may be formed from any medium that is capable of transmitting a signal such as, for example, conductive wires, conductive traces, optical waveguides, or the like. In some embodiments, the communication paths 204, 224 may facilitate the transmission of wireless signals, such as WiFi, Bluetooth®, Near Field Communication (NFC) and the like. Moreover, the communication paths 204, 224 may be formed from a combination of mediums capable of transmitting signals. In one embodiment, the communication paths 204, 224 comprises a combination of conductive traces, conductive wires, connectors, and buses that cooperate to permit the transmission of electrical data signals to components such as processors, memories, sensors, input devices, output devices, and communication devices. Accordingly, the communication paths 204, 224 may comprise a vehicle bus, such as for example a LIN bus, a CAN bus, a VAN bus, and the like. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

The mobile device system 200 and the vehicle system 220 include one or more memory modules 206, 226 respectively, which are coupled to the communication paths 204, 224. The one or more memory modules 206, 226 may comprise RAM, ROM, flash memories, hard drives, or any device capable of storing machine readable and executable instructions such that the machine readable and executable instructions can be accessed by the processors 202, 222. The machine readable and executable instructions may comprise logic or algorithm(s) written in any programming language of any generation (e.g., 1GL, 2GL, 3GL, 4GL, or 5GL) such as, for example, machine language that may be directly executed by the processors 202, 222 or assembly language, object-oriented programming (OOP), scripting languages, microcode, etc., that may be compiled or assembled into machine readable and executable instructions and stored on the one or more memory modules 206, 226. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. In some embodiments, the one or more memory modules 206, 226 may store data related to status and operating condition information related to one or more vehicle components, e.g., brakes, airbags, cruise control, electric power steering, battery condition, and so forth.

The mobile device system 200 and the vehicle system 220 may include one or more sensors 208, 228. Each of the one or more sensors 208, 228 is coupled to the communication paths 204, 224 and communicatively coupled to the processors 202, 222. The one or more sensors 208 may include one or more motion sensors for detecting and measuring motion and changes in motion of the vehicle. The motion sensors may include inertial measurement units. Each of the one or more motion sensors may include one or more accelerometers and one or more gyroscopes. Each of the one or more motion sensors transforms sensed physical movement of the vehicle into a signal indicative of an orientation, a rotation, a velocity, or an acceleration of the vehicle. The one or more sensors may also include a microphone, a motion sensor, a proximity sensor, and so forth. The one or more sensors 208, 228 may also be capable of detecting heart rates, pulse rates, and so forth. The one or more sensors 208, 228 may also include temperature sensors.

Still referring to FIG. 2, the mobile device system 200 and the vehicle system 220 optionally includes satellite antennas 210, 230 coupled to the communication paths 204, 224 such that the communication paths 204, 224 communicatively couple the satellite antennas 210, 230 to other modules of the mobile device system 200. The satellite antennas 210, 230 are configured to receive signals from global positioning system satellites. Specifically, in one embodiment, the satellite antennas 210, 230 include one or more conductive elements that interact with electromagnetic signals transmitted by global positioning system satellites. The received signal is transformed into a data signal indicative of the location (e.g., latitude and longitude) of the satellite antennas 210, 230 or an object positioned near the satellite antennas 210, 230, by the processors 202, 222. The location information may be included in context datapoints discussed above.

The mobile device system 200 and the vehicle system 220 may include network interface hardware 212, 234 for communicatively coupling the mobile device system 200 and the vehicle system 220 with the server 114, e.g., via communication network 112. The network interface hardware 212, 234 is coupled to the communication paths 204, 224 such that the communication path 204 communicatively couples the network interface hardware 212, 234 to other modules of the mobile device system 200 and the vehicle system 220. The network interface hardware 212, 234 may be any device capable of transmitting and/or receiving data via a wireless network, e.g., the communication network 112. Accordingly, the network interface hardware 212, 234 may include a communication transceiver for sending and/or receiving data according to any, wireless communication standard. For example, the network interface hardware 212, 234 may include a chipset (e.g., antenna, processors, machine readable instructions, etc.) to communicate over wireless computer networks such as, for example, wireless fidelity (Wi-Fi), WiMax, Bluetooth®. IrDA, Wireless USB, Z-Wave, ZigBee, or the like. In some embodiments, the network interface hardware 212, 234 includes a Bluetooth® transceiver that enables the mobile device system 200 and the vehicle system 220 to exchange information with the server 114 via Bluetooth®.

The network interface hardware 212, 234 may utilize various communication protocols to establish a connection between multiple mobile device and/or vehicles, example, in embodiments, the network interface hardware 212, 234 may utilize a communication protocol that enables communication between a vehicle and various other devices, e.g., vehicle-to-everything (V2X). Additionally, in other embodiments, the network interface hardware 212, 234 may utilize a communication protocol that is dedicated for short range communications (DSRC). Compatibility with other comparable communication protocols are also contemplated.

It is noted that communication protocols include multiple layers as defined by the Open Systems Interconnection Model (OSI model), which defines a telecommunication protocol as having multiple layers, e.g., Application layer, Presentation layer, Session layer, Transport layer, Network layer, Data link layer, and Physical layer. To function correctly, each communication protocol includes a top layer protocol and one or more bottom layer protocols. Examples of top layer protocols (e.g., application layer protocols) include HTTP, HTTP2 (SPRY), and HTTP3 (QUIC), which are appropriate for transmitting and exchanging data in general formats. Application layer protocols such as RTP and RTCP may be appropriate for various real time communications such as, e.g., telephony and messaging. Additionally, SSH and SFTP may be appropriate for secure maintenance, MQTT and AMQP may be appropriate for status notification and wakeup trigger, and MPEG-DASH/HLS may be appropriate for live video streaming with user-end systems. Examples of transport layer protocols that are selected by the various application layer protocols listed above include, e.g., TCP, QUIC/SPDY, SCTP, DCCP, UDP, and RUDP.

The mobile device system 200 and the vehicle system 220 include cameras 214, 232. The cameras 214, 232 may have any resolution. In some embodiments, one or more optical components, such as a mirror, fish-eye lens, or any other type of lens may be optically coupled to the cameras 214, 232. In embodiments, the camera may have a broad angle feature that enables capturing digital content within a 150 degree to 180 degree arc range. Alternatively, the cameras 214, 232 may have a narrow angle feature that enables capturing digital content within a narrow arc range, e.g., 60 degree to 90 degree arc range. In embodiments, the one or more cameras may be capable of capturing high definition images in a 720 pixel resolution, a 1080 pixel resolution, and so forth. The cameras 214, 232 may capture images of a face or a body of a user and the captured images may be processed to generate data indicating the status of the user.

In embodiments, the mobile device system 200 and the vehicle system 220 may include displays 216, 236 for providing visual output. The displays 216, 236 may output digital data, images and/or a live video stream of various types of data. The displays 216, 236 are coupled to the communication paths 204, 224. Accordingly, the communication paths 204, 224 communicatively couple the displays 216, 236 to other modules of the mobile device system 200 and the vehicle system 220, including, without limitation, the processors 202, 222 and/or the one or more memory modules 206, 226.

Still referring to FIG. 2, the server 114 may be a cloud server with one or more processors, memory modules, network interface hardware, and a communication path that communicatively couples each of these components. It is noted that the server 114 may be a single server or a combination of servers communicatively coupled together.

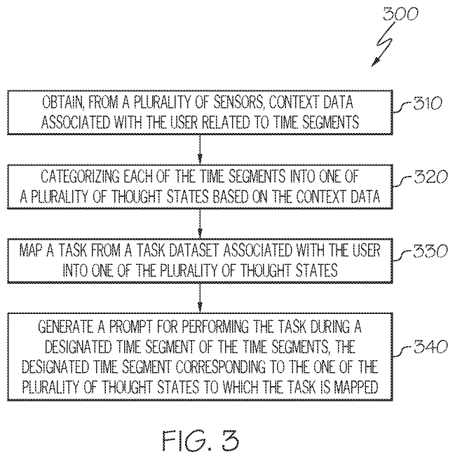

FIG. 3 depicts a flow chart 300 for generating and outputting a prompt for performing a task in a designated time segment, according to one or more embodiments described and illustrated herein. In embodiments, a plurality of interactions that the user 102 may have with the mobile device 103 may be tracked by one or more sensors installed as part of the mobile device 103. These interactions may also monitored, tracked, and stored in memory of one or more devices that are external to the mobile device 103, e.g., the server 114, one or more third party servers, and so forth. The one or more sensors 208 of the mobile device 103 may monitor various physiological characteristics of the user 102, e.g., a body temperature, a pulse rate, a heart rate, the number of steps that the user has taken, a distance the user 102 may have walked, and so forth. Additionally, the mobile device 103 may monitor interactions that the user 102 may have with various digital applications on his mobile device 103, e.g., scheduling appointments for various tasks, modifying existing appointments, canceling appointments, and so forth. The mobile device 103 may also be configured to analyze and monitor times when the user performs tasks.

For example, the mobile device 103 may determine that the user 102 communicates text messages, participates in video conferences, and so forth, consistently at certain time periods, e.g., between 6:00 PM and 8:00 PM on most Wednesdays, Fridays, and Saturdays. The mobile device 103 may determine that the user 102 performs scheduling appoints during a certain time window in the morning, e.g., between 7:30 AM and 8:00 AM. A plurality of other such interactions may be tracking, analyzed, and collated, automatically and without user intervention, by the mobile device 103.

In block 310, the processor 202 of the mobile device 103 obtains, from a plurality of sensors, context data associated with the user. The context data is also associated with various time segments. In embodiments, context data relates to one or more physiological characteristics of the user (e.g., various vital signs that are detected and tracked in real time), data relating to tasks and appointments that are scheduled by the user 102 (e.g., using the mobile device 103), patterns associated with these appointments, time periods when the user 102 performs certain types of tasks, and so forth. Context data may also include tracking, monitoring, and correlating the time periods during which various tasks are performed with the physiological data such as heart rate, pulse rate, body temperature, and so forth. In embodiments, other physiological data such as blood pressure, blood sugar levels, and so forth, may be accessed by the mobile device 103, e.g., via communicating with the server 114 via the communication network 112. It is noted that the types of context data mentioned in this disclosure are non-limiting.

In block 320, the processor 202 of the mobile device 103 may categorize each of the time segments into one of a plurality of thought states based on the context data. In embodiments, based on the obtained context data, the processor 202 of the mobile device 103 may categorize each time segment associated with, e.g., a day, hours, etc., into one or more of a plurality of thought states. In embodiments, the time segments may be two-hour time periods ranging from, e.g., 6:00 AM to 8:00 PM during a typical workweek. In embodiments, each two-hour time period ranging from 6:00 AM to 8:00 PM may be categorized into a long-term based thought state or a short-term instinctive reaction based thought state. For example, time blocks between 6:00 AM to 8:00 AM may be categorized into a long-term based thought state based on the context data associated with the user. Additionally, the categorizing of each time period may also be based on context data associated with a plurality of other users with varying physiologies, demographics, habits, and so forth.

In embodiments, the long-term based thought state may be a state in which critical and substantive thinking about solving complex problems may occur. Additionally, in such a thought state, thinking or activity that requires significant effort, time, and energy may be performed, e.g., analysis related to purchasing stock, ideas for creating novel products and/or services, analyzing an investment property for purchase, writing a novel, a short story, and so forth. In contrast, short-term instinctive reaction based thought state may relate to a state in which quick decisions are made, e.g., what to eat for lunch, when to schedule a dentist's appointment, planning game night with family, purchasing a gift for a family member, etc. In embodiments, the categorizing of the time segments may be performed automatically and without user intervention. In embodiments, the categorizing may also be performed manually by the user 102.

In block 330, the processor 202 of the mobile device 103 may map a task from a task dataset associated with the user into one of the plurality of thought states, e.g., long-term based thought state or short-term instinctive reaction based thought state. It is noted that a plurality of other thought states are also contemplated. In some embodiments, the plurality of thought states may be more than two thought states based on multiple characteristics of the thought states. For example, the plurality of though states may include a long-term logical thought state, a long-term creative thought state, a short-term logical thought state, and a short-term creative thought state. In embodiments, the task dataset may include a plurality of different types of tasks with varying levels of difficulty, e.g., from tasks for scheduling various duties such as (e.g., purchasing groceries, scheduling doctors appointments, deciding what to eat for lunch, where to do go to purchase a suit or dress, etc.), to tasks related to analyzing your 401K plan, purchasing stocks, determining appropriate investment strategies, analyzing a real estate deal, writing a short story, and so forth. In embodiments, the user 102 may manually map a task from the dataset into a particular thought state. For example, the user 102 may interact with one or more software applications operating on the mobile device 103, input a particular task into an interface of the software application (list, table, etc.), and categorize the particular task into one of a plurality of thought states.

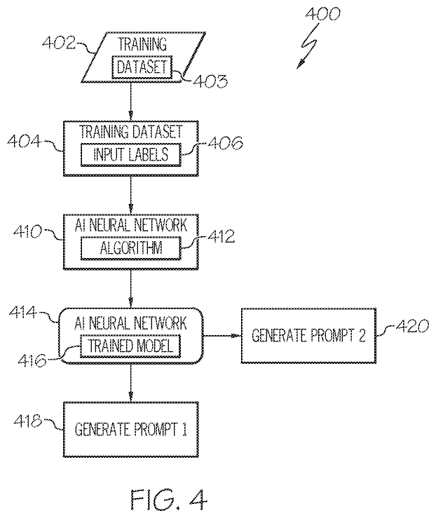

In other embodiments, the processor 202 may, utilizing an artificial intelligence trained model (as described in FIG. 4), map a particular task that is input into a user interface by the user 102 into either the long term based thought state, the short-term instinctive reaction based thought state, or various additional thought states. As stated, these tasks may include scheduling an appointment for various routine tasks or working on solving more complex problems.

In block 340, the processor 202 of the mobile device 103 may generate a prompt for performing the task during a designated time segment of the time segments. The designated time segment may correspond to one of the plurality of thought states to which the task is mapped. In embodiments, as described above, a prompt may be output on a display of the mobile device 103 in association with a particular time segment, based on an analysis of context data, and various thought states into which one or more of various tasks may be mapped. For example, the user 102 may input a task into an interface of a software application, and the software application may, automatically and without user intervention, suggest that the user perform the task during a designated time segment. The designated time segment may have been determined to be suitable depending on the complexity of the task. For example, a time segment between 6:00 AM and 8:00 AM may be suggested for a task that requires significant creativity and concentration, e.g., writing a report, short story, portions of a novel, and so forth. On a particular day, between 6:00 AM and 8:00 AM (e.g., 6:30 AM), a prompt may automatically be generated requesting the user to perform the task.

The artificial intelligence trained model may be dynamically trained in real time using context data associated with the user 102 that is gathered each time a user interacts with the mobile device 103, and based on a real time detection and analysis of various physiological characteristics as described above. For example, each time a user enters a task, responds to a prompt (e.g., acknowledges and accepts a suggestion to perform a task at a designated time segment, rejects a suggestion to perform a task, reschedules a task from a particular time to another time), data associated with these decisions are incorporated into a dynamically updated training dataset that is utilized to train the artificial intelligence trained model. Additionally, data of the heart rate, pulse rate, body temperature, etc., are associated with the times when a prompt is provided to the user 102 and the manner in which the user 102 responds to these prompts may be monitored, tracked, and incorporated into the training dataset that is utilized to train the artificial intelligence trained model.

FIG. 4 illustrates a flowchart 400 for training the artificial intelligence trained model that is utilized by the task prompt generation system of the present disclosure to generate prompts, according to one or more embodiments described and illustrated herein. In embodiments, in block 402, context data, physiological data, and so forth may be obtained and included as part of training dataset 403 based on various actions of the user 102, interactions with one or more devices, and the physical condition of the user 102. It is noted that the training dataset 403 may also include actions, interactions, and physical conditions of a plurality of other users. In block 404, one or more data input labels 406 may be included in association with the context data and physiological data in the training dataset 403. In block 410, an artificial neural network algorithm 412 may be utilized to train the artificial intelligence based model described herein. In block 414, the artificial intelligence neural network trained model 416 may be trained using natural language based techniques, heuristics based techniques, one or more artificial neural networks (ANNs), Markov decision process, and so forth. In blocks 418 and 420, prompts 1 and 2 may be generated. These prompts may be associated with tasks that are to be performed at designated time segments associated with short-term instinctive reaction based thought states or long-term based thought states, as described in the present disclosure.

In embodiments, a convolutional neural network (CNN) may be utilized. For example, a convolutional neural network (CNN) may be used as an ANN that, in a field of machine learning, for example, is a class of deep, feed-forward ANNs that may be applied for audio-visual analysis CNNs may be shift or space invariant and utilize shared-weight architecture and translation invariance characteristics. Additionally or alternatively, a recurrent neural network (RNN) may be used as an ANN that is a feedback neural network. RNNs may use an internal memory state to process variable length sequences of inputs to generate one or more outputs. In RNNs, connections between nodes may form a DAG along a temporal sequence one or more different types of RNNs may be used such as a standard. RNN, a Long Short Term Memory (LSTM) RNN architecture, and/or a Gated Recurrent Unit RNN architecture. A plurality of other techniques are also contemplated.

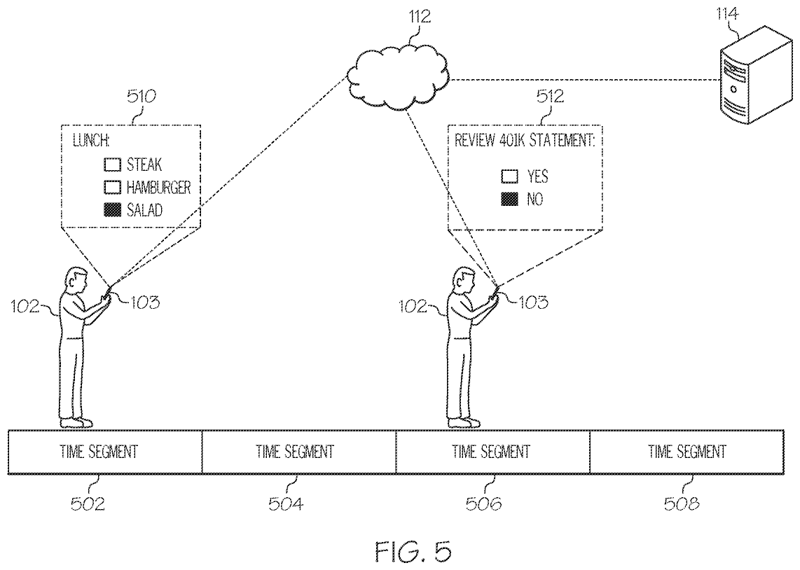

FIG. 5 schematically depicts an example operation of the task prompt generation system of the present disclosure in which prompts for performing a routine task and a complicated task are output onto a display of a mobile device, according to one or more embodiments described and illustrated herein. For example, during a typical workday, the user 102 may interact with the mobile device 103 a number of times in order to, e.g., answer calls, schedule and reschedule meetings, check entails, and so forth. As previously stated, data associated with all of this activity may be monitored, tracked, and utilized to dynamically train the artificial intelligence trained model. In embodiments, on Monday of a weekday, the user 102 may sense a vibration from the mobile device 103, check the display on his phone, and receive a prompt 510 requesting him to make a selection regarding what he would like to eat for lunch. For example, the prompt 510 may output various food items that the user may have previously ordered (e.g., using an Uber Eats® application, Grubhub®, and so forth). The user 102 may select one of these items. As such, during lunch, the additional effort required to think about making a decision to select an item to eat may be reduced.

In embodiments, the artificial intelligence trained model may, automatically, and without user intervention, generate a prompt for selecting a food item for lunch during a time segment 502 that may be determined as suitable for making routine decisions, e.g., picking a food item for lunch, scheduling a doctor's appointment, voting for a candidate, selecting a gift for a family member, and so forth. The processor 202, based on analyzing, monitoring, and tracking context data associated with the user 102, may determine that the time segment 502 is suitable for performing tasks or decisions that only require short-term instinctive reaction thought processes, which corresponds to the short-term instinctive reaction based thought state.

In embodiments, the processor 202, utilizing the artificial intelligence may track, analyze, and monitor context data, and determine that the user 102 tends to schedule and perform various routine tasks between 10:30 AM and 11:00 AM (e.g., time segment 502). Additionally, during the time segment 502, one or more sensors 208 of the mobile device 103 may detect heart rate, pulse rate, body temperature (and other such physiological characteristics) and determine that the heart rate and pulse rate is slightly higher, indicating that the user 102 is interacting regularly with the mobile device 103. It is noted that data related to the heart rate, pulse rate, body temperature, etc., may be tracked by one or more sensors installed as part of the mobile device 103, or may be received by the mobile device 103 from one or more external devices, e.g., the server 114, other devices worn by the user 102 such a FitBit®, an iWatch®, etc.

In embodiments, on the same day of the week (i.e. Monday), the user 102 may sense another vibration from the mobile device 103, check the display on his phone, and receive a prompt 512 requesting him to review his 401K statement. The prompt 512 may be generated at time segment 506, e.g., at 1:00 PM, which is typically a time right after lunch. In response, the user 102 may acknowledge receipt of the prompt 512 and make a selection of “no” (e.g., a negative response). Such a response may be included as part of the training dataset 403 that is updated in real time. Additionally, the artificial intelligence trained model may analyze and be trained upon the training dataset 403. Additionally, physiological data associated with the time segment 506 may also be tracked, e.g., the heart rate, pulse rate, and so forth. The heart rate, pulse rate, etc., may be low, indicating that the user 102 has recently had lunch and may not be in a highly active state.

The processor 202 may, using the artificial intelligence trained model, determine that the time segment 506 may not be a suitable time for the user 102 to perform tasks that require significant thought, concentration, and effort, e.g., characteristics of tasks performed in the long-term based thought state. Data associated with the selection of “no” by the user 102 may be obtained, collated, and included as part of the training dataset 403 upon which the artificial intelligence trained model is dynamically trained. Additionally, as previously stated, data associated with various physiological characteristics of the user 102 may also be included in the training dataset 403 and associated with various time segments, e.g., time segments 502, 504, 506, and 508. The processor 202 may utilize the artificial intelligence trained model and determine that time segment 508 may be a better suited time segment in which the user may perform various complicated tasks.

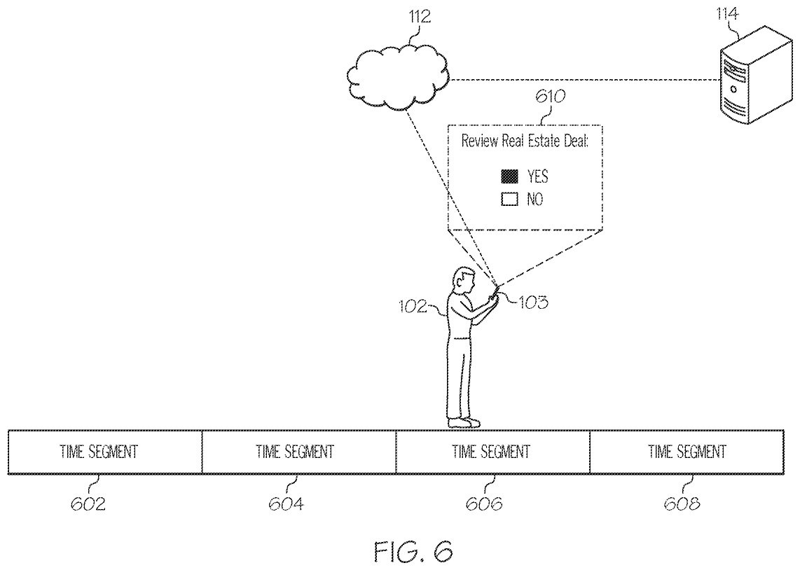

FIG. 6 schematically depicts another example operation of the task prompt generation system in which a prompt for performing a complicated task is automatically output onto a display of the mobile device, according to one or more embodiments described and illustrated herein.

In embodiments, the processor 202, utilizing the artificial intelligence trained model that is dynamically trained (i.e. trained in real time) on context data, physiological data, etc., may generate an additional prompt during a time segment 606 on a different work day. Specifically, based on analyzing the input received from the user 102 regarding the performance of a complicated task at time segment 506, and utilizing the artificial intelligence trained model, the processor 202 may generate a prompt 610 recommending that the user 102 perform a review of a real estate deal (e.g., a task may be associated with the long-term thought state) at a more suitable time, e.g., a time that varies from the time segment 506. For example, the processor 202 may generate a prompt at time segment 606, which refers to a time block between 10:30 AM to 11:30 AM. In embodiments, the user 102 may provide a confirmation response (e.g., select “yes”) as illustrated in FIG. 6. It is noted that other time segments (e.g., time segments 602, 604, and 608) may also be determined as suitable for performing tasks that may be categorized in association with long-term thought state. It is noted that reviewing a real estate deal may be a complicated task that requires reviewing various financial documents, P/L statements, tax records, and so forth. In other embodiments, the user 102 may input a particular task (e.g., an additional task), and receive, in real time, a prompt for performing the inputted task at a different designated time segment.

The method includes obtaining, from a plurality of sensors, context data associated of the user related to time segments, categorizing each of the time segments into one of a plurality, of thought states based on the context data, mapping a task from a task dataset associated with the user into one of the plurality of thought states, and generating a prompt for performing the task during a designated time segment of the time segments, the designated time segment corresponding to the one of the plurality of thought states to which the task is mapped.

The terminology used herein is for the purpose of describing particular aspects only and is not intended to be limiting. As used herein, the singular forms “a,” “an,” and “the” are intended to include the plural forms, including “at least one,” unless the content clearly indicates otherwise. “Or” means “aid/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. The term “or a combination thereof” means a combination including at least one of the foregoing elements.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A method implemented by a processor of a device of a user, the method comprising:
obtaining, from a plurality of sensors, context data associated of the user related to time segments;
categorizing each of the time segments into one of a plurality of thought states based on the context data;
mapping a task from a task dataset associated with the user into one of the plurality of thought states; and
generating a prompt for performing the task during a designated time segment of the time segments, the designated time segment corresponding to the one of the plurality of thought states to which the task is mapped.

2. The method of claim 1, further comprising outputting the prompt for performing the task during the designated time segment on a display of the device.

3. The method of claim 1, further comprising:
receiving, from the user, a confirmation response to the prompt for performing the task during the designated time segment;
incorporating, by the processor, the confirmation response as part of a training dataset;
dynamically training in real time; by the processor; an artificial intelligence based model using the training dataset that includes the confirmation response; and
generating, by the processor, an artificial intelligence trained model based on the raining of the artificial intelligence based model.

4. The method of claim 3, further comprising:
inputting, by the user, an additional task into the task dataset;
mapping, using the artificial intelligence trained model that is dynamically trained, the additional task into one of the plurality of thought states; and
generating, using the artificial intelligence trained model that is dynamically trained, an additional prompt for performing the additional task during a different designated time segment of the time segments.

5. The method of claim 4, further comprising outputting, on a display of the device, the additional prompt for performing the additional task during the different designated time segment.

6. The method of claim 1, further comprising:
receiving, from the user, a negative response to the prompt for performing the task during the designated time segment;
incorporating, by the processor, the negative response as part of a training dataset;
dynamically training in real time, by the processor, an artificial intelligence based model using the training dataset that includes the negative response; and
generating, by the processor, an artificial intelligence trained model based on the training of the artificial intelligence based model.

7. The method of claim 6, further comprising:
inputting, by the user, an additional task into the task dataset;
mapping, using the artificial intelligence trained model that is dynamically trained, the additional task into one of the plurality of thought states; and
generating, using the artificial intelligence trained model that is dynamically trained, an additional prompt for performing the additional task during a different designated time segment of the time segments.

8. The method of claim 7, further comprising outputting, on a display of the device, the additional prompt for performing the additional task during the different designated time segment.

9. The method of claim 1, wherein the plurality of thought states include a long-term based thought state and a short-term instinctive reaction based thought state.

10. The method of claim 1, wherein the context data associated with the user relates to a relaxed condition of the user, an excited condition of the user, a reaction time of the user.

11. The method of claim 1, wherein the context data associated with the user relates to a heart rate or a pulse rate.

12. The method of claim 1, wherein the plurality of sensors include a motion sensor, a camera, physiological monitoring sensor, and a microphone.

13. The method of claim 1, further comprising obtaining, from an electronic calendar of the user, the context data of the user that is related to the time segments.

14. The method of claim 1, wherein the plurality of sensors are integrated into an additional device that is external to the device of the user, the plurality of sensors are communicatively coupled to the device.

15. The method of claim 1, wherein the task dataset includes a plurality of tasks such as scheduling a doctor's appointment, voting for a candidate, purchasing a gift, and purchasing stock.

16. A system including:
a plurality of sensors; and
a device including a processor configured to:
obtain, from the plurality of sensors, context data associated of a user related to time segments;
categorize each of the time segments into one of a plurality of thought states based on the context data;
map a task from a task dataset associated with the user into one of the plurality of thought states; and
generate a prompt for performing the task during a designated time segment of the time segments, the designated time segment corresponding to the one of the plurality of thought states to which the task is mapped.

17. The system of claim 16, wherein the processor is further configured to output the prompt for performing the task during the designated time segment on a display of the device.

18. The system of claim 16, wherein the processor is further configured to:
receive, from the user, a confirmation response to the prompt for performing the task during the designated time segment;
incorporate, by the processor, the confirmation response as part of a training dataset;
dynamically train in real time, by the processor, an artificial intelligence based model using the training dataset that includes the confirmation response; and
generate an artificial intelligence trained model based on the training of the artificial intelligence based model.

19. The system of claim 18, wherein the processor is further configured to:
input, by the user, an additional task into the task dataset;
map, using the artificial intelligence trained model that is dynamically trained, the additional task into one of the plurality of thought states; and
generate, using the artificial intelligence trained model that is dynamically trained, an additional prompt for performing the additional task during a different designated time segment of the time segments.

20. The system of claim 16, wherein the task dataset includes a plurality of tasks such as scheduling a doctor's appointment, voting for a candidate, selecting a food item, purchasing a gift, and purchasing stock.
